(19) United States
(12) Patent Application Publication
(10) Pub. No.: US 2011/0192967 A1
(43) Pub. Date: Aug. 11, 2011

(54) DEVICE FOR READING LUMINESCENT SYMBOLS AND IMAGES

(75) Inventors: Michail U. KVASHA, Moscow (RU); Alexey V. LEZHNEV, Moscow (RU); Dmitry V. PEBALK, Moscow (RU); Galina N. DOROZHKINA, Moscow region (RU)

(73) Assignee: LLC FLUORESCENT INFORMATION TECHNOLOGY, Moscow (RU)

(21) Appl. No.: 12/968,307

(22) Filed: Dec. 15, 2010

(30) Foreign Application Priority Data
Feb. 8, 2010 (RU) 2010103908

(51) Int. Cl. G06K 7/10

(52) U.S. Cl. 250/271; 235/468

(57) ABSTRACT

Optical device which is designed to read information in the form of luminescent symbols and images, which consists of an illuminator with an array of light emitting diodes which excite luminescence and an optical system which projects the information which is being read onto the sensor of the scanner of the optoelectronic system which consists of an electronic control circuit, optical filter and objective lens with a light-guiding lamp which is provided with an output window, and which is connected to the housing of the data collection terminal or scanner by a constructive connection and switching connections for controlling the light emitting diodes of the device, characterized in that the switching connections between the scanner and device are implemented optically by photosensors which control the illuminator and sighting system, which are mounted in the housing of the device, and which receive the light pulses of the scanner.

### 1. OBJECT OF THE INVENTION

The invention is intended for the industry of electronic equipment and accounting and monitoring means which use luminescent marks, images and bar codes as information-protective attributes in production and movement of special inventory goods, clerical work, securities circulation, accounting and checking the genuineness of objects of museum and artistic value, pharmacology and the cosmetics industry.

### 2. TECHNICAL LEVEL

The operating principle of luminescent photoscanners is based on excitation of luminescence with light and image recording with subsequent image processing. They read not only luminescent bar codes, but also various marks, conventional graphic symbols, inscriptions, etc. which have been applied using special compositions and inks which include a luminophore.

US200502304A is known in which a system is proposed which makes it possible to read an invisible bar code which has been printed using luminescent inks and which uses subsequent registration of changes in the intensity of the emitted light by a photodiode when irradiated with a UV source. This system is intended for reading only linear bar codes; this sharply limits the range of its application. In addition, it has considerable mass and size parameters; this does not allow its use as a mobile device.

U.S. Pat. No. 6,832,725 B2 is known in which the lamp of the photoscanner is an optical head which has a built-in array of light emitting diodes with the wavelengths which are necessary for illuminating the symbols being read and which are controlled by the scanner controller. This design can be used to read both luminescent symbols and images as well as standard print symbols, but when the characteristics of the luminophore which is being used changes, expensive modification of the scanner lamp is required. In addition a scanner built using this design due to the complexity of the construction will be much more expensive than ordinary photoscanners which are used at sales and control points.

U.S. Pat. No. 7,357,326B2 is known for a manual scanner of invisible bar codes in which for reading of invisible bar codes an optical device is used in the form of an attachment which includes a lamp with a set of light emitting diodes with radiation wavelengths in the range of 350-420 nm and an optical system consisting of an objective lens and a filter. The connected attachment is electrically connected via switching contacts to the circuit of the scanner itself. This design makes it possible to read luminescent bar codes and images, but is not a versatile design since it is constructionally tied to the photoscanner of a specific manufacturer; this increases the cost of the set.

U.S. Pat. No. 7,370,801B2 is most similar to the current invention. The inventors of this patent have proposed a design similar to the one set forth in the previous patent. The data collection terminal (DCT) which includes the head of the photoscanner is equipped with an optical device-attachment which consists of a housing with electrical contacts which switch with the DCT, as a minimum one UV light emitting diode of the illuminator which is located at an angle to the axis of the optical system which projects the luminescent image of the bar code onto the sensor. The attachment is connected to the DCT using detachable switching electrical contacts for feeding power to the UV light emitting diodes and is connected to the scanner housing an end fixing connection. The DCT without the attachment makes it possible to read standard bar codes, but fitted with the attachment—to read invisible bar codes with luminophores. The disadvantages of this design can include the disposition of the light emitting diodes at an angle to the optical axis; this entails uneven illumination of the symbol being read and as a result a reduction of the stability of reading. The narrow output window of the attachment does not allow illumination of the relatively large surface on which the symbol being read is located. This makes it difficult to find an invisible bar code or image on nonstandard surfaces of large area (in particular, on art glass objects). Another defect is the limitation to a certain scanner manufacturer; this does not allow the attachment to be a versatile design for photoscanners, leads to an increase in the cost of the equipment set, and slows down development of the technologies of luminescent marking. Thus, the company InData Systems (www.indatasys.com) in alliance with HandHeld Products is building and selling sets for reading luminescent symbols at prices of 3-6 thousand USD.

### 3. DESCRIPTION OF THE INVENTION

The invention relates to optical devices for reading of symbols and images, more specifically to scanners for reading bar codes and images based on matrix photodetector sensors of the CCD (charge coupled devices) and CMOS (complementary metal-oxide-semiconductor) type, more specifically to scanners of luminescent bar codes and images. The proposed invention can be used in systems of concealed registration/reading of bar codes, marks and images on securities, objects of high artistic and museum value, and also for reading the marking of industrial articles and goods, including also their parts or original components, of varied purpose, for example on wrappers, packages, etc, of food products, pharmacological and cosmetological preparations, but it is not limited to the aforementioned. The proposed invention can also be used in direct part marking equipment in the reading of bar codes, symbols which are obtained by needle impact, laser or inkjet marking using luminophores which increase the contrast of the image, for example for marking of spare parts and components in the automotive, aviation, space, nuclear, electronic and other industry, but is not limited to the aforementioned.

For a number of years bar coding has been widely used around the world in the industry of technologies of accounting, monitoring and verifying the genuineness of material objects. The advent of bar code scanners based on CCD and CMOS sensors (photoscanners) gave impetus to the development of two-dimensional bar codings which have higher information capacity and noise immunity. The use of luminescing substances for printing or applying concealed images and bar codes expands the possibilities of marking from the viewpoint of increasing security and protection from counterfeiting. The technology of marking using luminophores is used in pharmacology and the cosmetics industry. The US Postal Service uses invisible bar codes and images in mail stream control systems. Direct part marking symbols which have been modified with luminophores make it possible to significantly reduce expenses for marking of equipment in the production and tracking of the life cycle of spare parts and critical parts in the electronics, automotive and aerospace industry. The application of luminescent bar codes, marks and images is done using methods of direct jet, stencil or thermotransfer printing, laser engraving or methods of filling modified surfaces with compositions containing a luminophore. A description of various methods and compositions used which include luminophores is cited for example in patents U.S. Pat. No. 5,693,693A, U.S. Pat. No. 6,203,069B1, US2003/0012562a1, RU2165954 and others. Luminophores are dyes which have a Stokes or anti-Stokes shift of the radiation band. When using Stokes luminophores for concealed symbols the excitation band of the dye generally lies in a wavelength range of 350-420 nm, and the radiation band in the 470-700 nm range. For anti-Stokes luminophores these bands lie in the 940-1000 nm and 500-680 nm range, respectively. These characteristics of the materials used have made it possible for developers of equipment in building the lamp (illuminator) of the scanner to use light emitting diode radiators of the ultraviolet (UV) and infrared (IR) ranges, the radiation powers and operating characteristics of which have recently reached a level which is sufficient for building compact, high-efficiency devices.

The object of this invention is to build an optical device in the form of a detachable attachment for reading of luminescent symbols which with minor design changes of the housing could be used with any, including a low-budget model, photoscanner, without introducing any changes into its construction. This object is achieved by building a device which consists of a housing with elements for fastening to the photoscanner, as a minimum one radiating light emitting diode for illuminating the symbol being read, optical filters for selection of the luminescent radiation which is projected onto the photosensitive sensor of the scanner, a power feed device of the light emitting diodes with switching components and electronic control elements.

### 4. BRIEF DESCRIPTION OF THE FIGURES

FIG. 1 shows the optomechanical circuit of the attachment in assembly with the photoscanner.

FIG. 1a shows a view of the attachment from the screen side.

FIG. 2 shows the transmission band of the wavelengths of the radiation which has been transmitted by the receiving channel of the photoscanner.

FIG. 3 shows a characteristic curve for a filter which is placed in the illuminator of the attachment in front of the light emitting diodes for blocking the incidence of long-wave parasitic radiation of the light emitting diodes.

FIG. 4 shows the passband of the filter which is installed in the receiving channel of the attachment for blocking the radiation of the primary wavelengths of the light emitting diodes.

FIG. 5 shows the optoelectronic circuit of the attachment.

FIG. 6 shows a photograph of the Metrologic MS1690 Focus photoscanner which is equipped with the attachment and which is described in Example 1.

FIG. 7 shows an invisible symbol of a two-dimensional bar code which has been photographed using the Metrologic MS1690 Focus photoscanner fitted with the attachment.

FIG. 8 shows a Casio DT-X11M30E data collection terminal which is equipped with the attachment and which is described in Example 2.

### 5. DISCLOSURE OF THE INVENTION

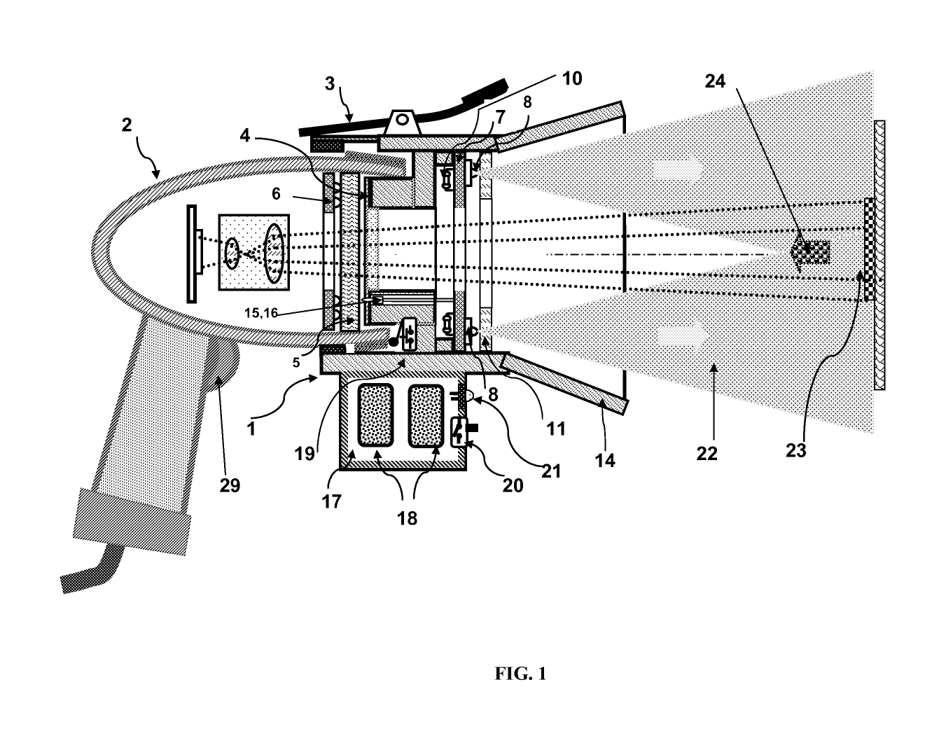

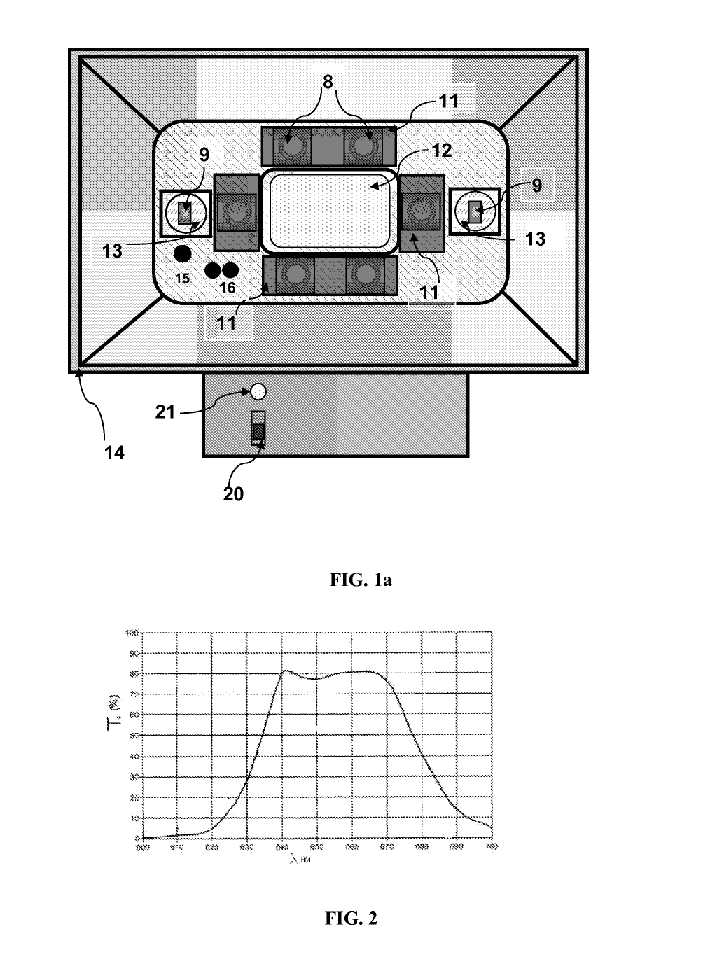

The essence of the invention consists in that a detachable construction of the optical device is devised in the form of an attachment (FIG. 1, FIG. 1a) for a photoscanner which has an independent power supply of the light emitting diodes which is controlled by light pulses which have been received from the scanner by means of photosensors. The optical device (attachment) consists of a housing 1 which with its internal surface is mechanically fastened on the outer surface of the housing of the photoscanner 2 on the receiving window side. The fastening mechanism 3 can depend on the specific model of the scanner or can be universal, a type of cam fastener, or other similar ones, and as a minimum contains one clamp which reliably fixes the housing of the attachment on the scanner housing. The housing of the optical device is made of plastic or a lightweight metallic alloy of the duraluminum type.

The optical device-attachment can be mounted in a single housing which is securely fastened on the scanner housing. But an optical device (attachment) can also be built which consists of functional blocks which can be assembled into a single construction by means of the corresponding fastening devices, for example clamps, catches, guide pins or grooves, etc., and also switching electrical contacts. For example, one of the units can be a universal fitting assembly which is independent of the model of the scanner, for example with rod, cam, eccentric or any other fasteners, which is fastened securely on the surface of the scanner regardless of its dimensions and shape. The optoelectronic unit to which the power supply unit or grid adapter unit can be connected can be attached in turn to the fasteners and guides of this assembly.

A light-absorbing coating 4 for blocking of the radiation of the scanner's “own” light emitting diodes 6 is applied to the surface of the housing which adjoins the input window of the scanner except for the zone of the field of view of the sensor. An illuminator plate 7 is mounted in the attachment housing, from one side of which as a minimum one light emitting diode of luminescent highlighting 8 is mounted with the required wavelength of the radiation for illumination of the symbol being read and as minimum two sighting light emitting diodes 9.

Another possibility is mounting arrays of light emitting diodes with different radiation spectra on the illuminator plate or on a construction of several plates. As a minimum there can be two of these light emitting diodes. For example, one array of light emitting diodes with a radiation spectrum in the UV spectral range can excite Stokes luminescence of one dye, and another light emitting diode array with a radiation spectrum in the IR spectral range can excite anti-Stokes luminescence of the other dye. These arrays of light emitting diodes can work both simultaneously when started from a single electronic switch, and also independently of one another. In this case, in the electronic circuit there is as a minimum one manual switch of the luminescent highlighting modes which makes it possible to selectively choose the region of spectral excitation of the optical symbols and images being read in the region of their optical absorption. The arrays of sighting light emitting diodes can be built similarly. The corresponding spectral filters are inserted accordingly into the optical channel in this case.

Another possibility is the use of an array of light emitting diodes which consists as a minimum of two light emitting diodes with different directional patterns. In this case exact positioning of the optical device in the process of reading the optical information can be achieved. Accordingly, in this case in the electronic circuit there is as a minimum one manual switch of the luminescent highlighting modes which makes it possible to selectively choose the mode of spectral excitation and light emitting diodes with certain spectral directional patterns.

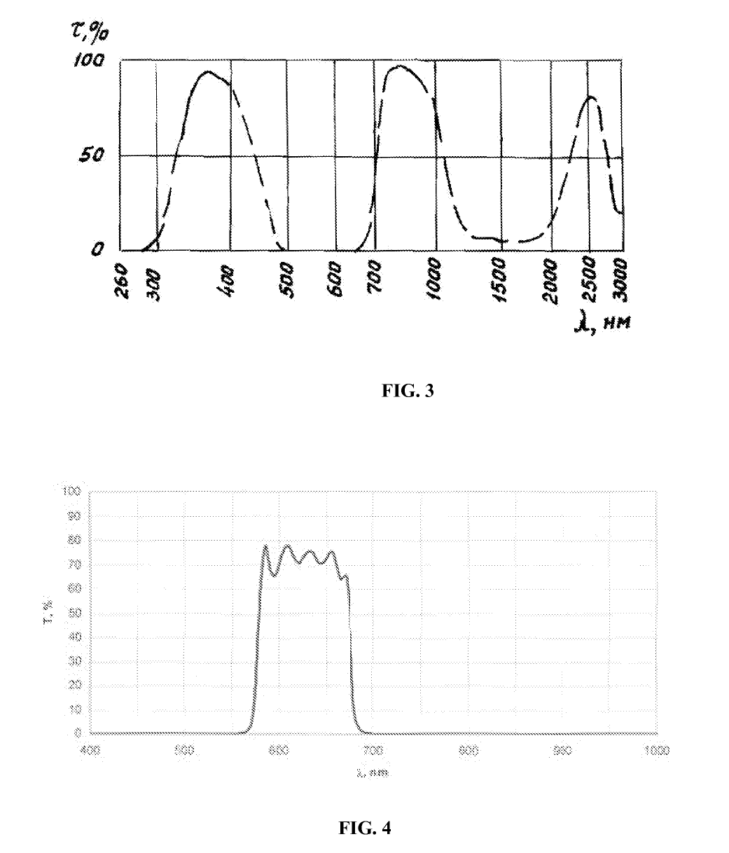

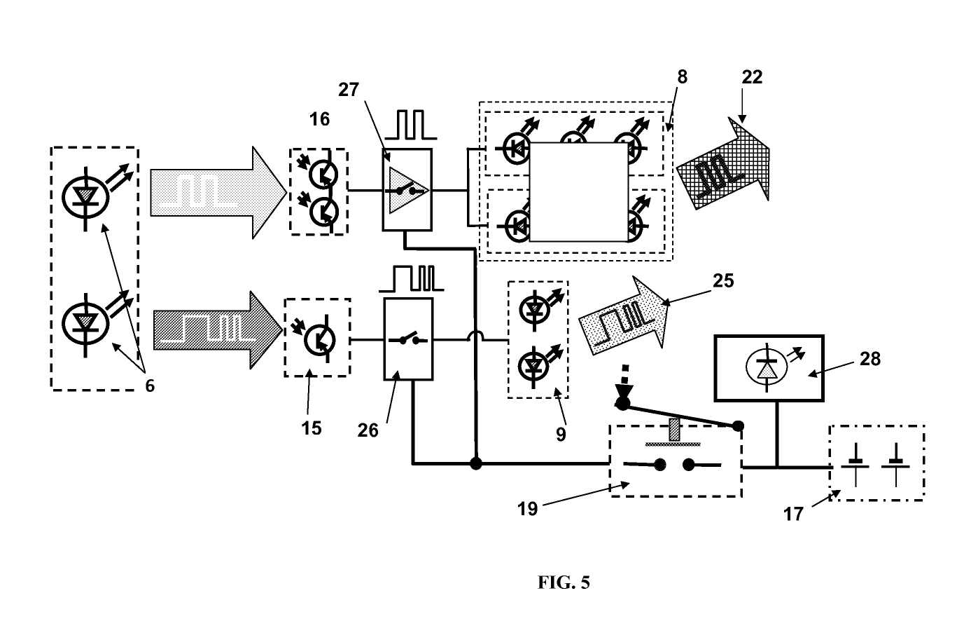

The components 10 of the electronic control circuit of the light emitting diode power supply are mounted on the other side of the plate. In the housing of the attachment there is an optical filter 11 which blocks the incidence of the long-wave part of the light emitting diode radiation onto the scanner sensor in operation with strongly reflecting surfaces, and a light filter 12 which blocks parasitic background from foreign sources of illumination and the radiation of the primary light emitting diode wavelengths which is reflected from the target surface. There can be manual or electromechanical changing of the filter 11 in the construction of the optical device. The characteristics of the filters 11, 12 depend on the luminophores used and have the exemplary form which is shown in FIG. 3 and FIG. 4. To form a sighting line, the housing mounts two spherical lenses 13 such that the light emitting diodes 9 are near the focal plane on the optical axis of the lenses. Two cylindrical lenses can be used for this purpose. The screen 14 which has the shape of a rectangular, round, oval or ellipsoidal bell is designed to protect the operator from the radiation of the light emitting diodes and from the incidence of external background onto the receiving channel of the scanner. The screen is made of the same material as the housing of the attachment. The inner surface of the screen has a mirror coating which concentrates the radiation of the light emitting diodes in the direction of the symbol which is being read. The photosensors 16 for controlling the light emitting diodes of the lamp 8 and the photosensor 15 which is the source of the signal for turning on the sighting light emitting diodes 9 with the attachment fitted are positioned primarily coaxially to the corresponding light emitting diodes of the scanner 2; the construction of the housing ensures a minimum gap between them to ensure effective triggering of the control circuit in the switching mode. The housing contains a compartment 17 for mounting as a minimum one power supply cell 18 in manufacture of the attachment with a self-contained power supply. If connection to an AC grid is allowed, there is no battery compartment in the housing of the attachment and power is sent through the corresponding jack for connection of the grid adapter with the necessary nominal voltage. A microswitch 19 for preventing engagement of the light emitting diodes of the attachment and a power supply switch 20 of a contact blade type are mounted in the attachment housing in the unfitted state. On the side wall of the attachment housing there is a light emitting diode 21 for display of the discharging of the power supply cells. The circuit for stabilization and control of the power supply of the light emitting diodes (FIG. 5) converts pulses from the photosensors 15, 16 into current pulses of the corresponding light emitting diodes 8 and 9, prevents engagement of the light emitting diodes in the unfitted state of the attachment, and signals the level of discharge of the cells in an attachment with a self-contained power supply. The current of the sighting light emitting diodes is controlled using an electronic switch 26 based on a n-p-n type field effect transistor, and the current through the light emitting diodes for illumination of the symbol which is being read is controlled by means of the specialized microcircuit 27 of the light emitting diode current stabilizer. The level of discharge of the cells is monitored by a circuit 25 which is composed of two n-p-n bipolar transistors and one light emitting diode indicator 21 which signals the necessity of replacement by its blinking. The control circuit of the light emitting diode power supply is not limited to the circuitry cited in this application. The luminescent symbols and images are read by the scanner with the proposed attachment by mounting it on the housing of the scanner, by turning on the scanner and turning on the power supply of the attachment. When the operator points the scanner with the attachment into the region in which a luminescent symbol is preferably located and pulls the “trigger” 29 of the scanner, the scanner's “own” light emitting diodes begin to flash, whose radiation is blocked by the attachment from entering the region of the symbol which is being read. Here the photosensors of the attachment generate current pulses for the sighting and illuminating light emitting diodes which flash by the radiation 22 and 25, and by means of exact sighting the operator points the scanner with the attachment at the symbol which is flashing by luminescent radiation 24 until it is read.

If it is a bar code, with successful reading and decoding the scanner emits an audio signal. When problems arise the distance from the attachment to the surface on which the symbol is located should be changed and the procedure should be repeated until a confirmation of reading is obtained. Reading of the luminescent marks and images is done similarly with the sole difference that the scanner here is controlled by specialized computer software. When the attachment is disconnected the scanner can read standard bar codes which are visible to the naked eye.

### 6. EXAMPLES OF THE TECHNOLOGY

The essence of the proposed invention is explained using examples of its specific claimed designs which however are not limiting, versions with references to the accompanying drawings, and figures.

### Example 1

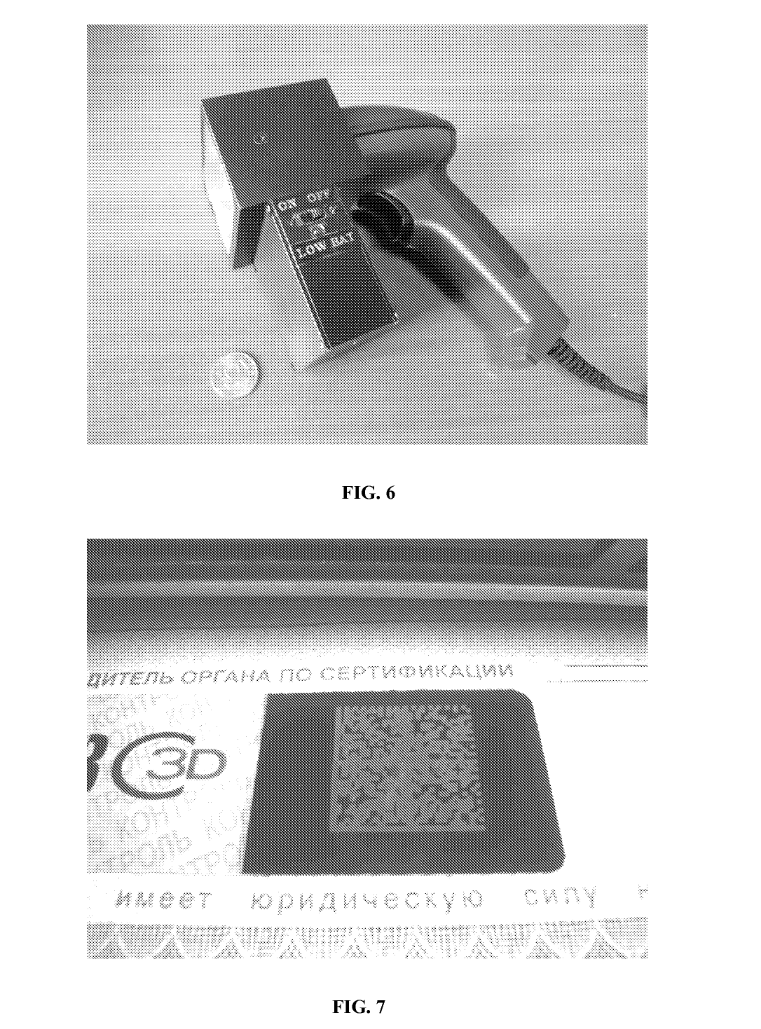

An attachment is produced for a photoscanner of two-dimensional bar codes Metrologic MS1690 Focus (FIG. 6). The housing of the attachment is made of duraluminum using the milling method. The housing has a throwover type clamp which makes it possible to reliably fasten the attachment to the housing of the scanner. The attachment mounts 6 UV light emitting diodes HPL-H77HV1BA-V3 with a radiation wavelength of 395 nm, a power of 35 mW and a divergence angle of 45°. Two light emitting diodes RF-BNS150TS-CD of blue illumination are used for sighting. The photosensors are L-32P3C phototransistors. An electronic switch based on a N-channel field effect transistor BSS138 is used to control the light emitting diode current. To control the UV light emitting diodes a microcircuit of a stabilizer of the current through the light emitting diodes of type DD312 in the TO-252 housing is used, and the light emitting diodes are connected in parallel by two series cascades of 3 light emitting diodes each. This made it possible to use two 9 volt cells of the “Krona” type for self-contained power supply of the attachment. Monitoring of the discharge level of the batteries is controlled by a circuit based on 2 n-p-n type KT3102 DM transistors. To prevent unauthorized engagement of the light emitting diodes in the unfitted position of the attachment a microswitch with a lug MX-1382 is used. To block parasitic radiation from the light emitting diodes a filter of glass CC4 which is 3 mm thick is used, a filter of glass OC11 which is 5 min thick is mounted in the receiving channel of the sensor for suppression of UV radiation. The attachment makes it possible to read invisible bar codes based on luminophores which radiate in the wavelength range of 600-650 nm and modified symbols with luminophore-filled depressions obtained using a point impact method (so-called dot peen symbol). A photograph of the luminescent symbol which is being read is shown in FIG. 7. Without the attachment the scanner makes it possible to read standard visible bar codes.

### Example 2

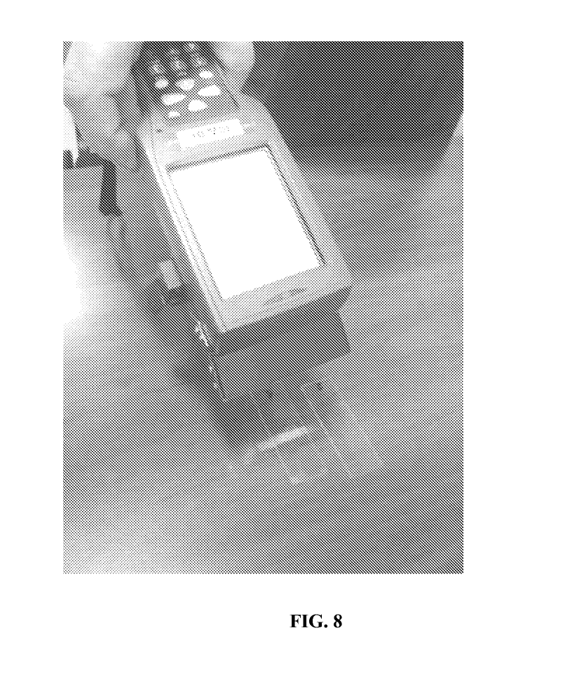

An attachment based on a Casio DT-X11M30E DCT is produced (FIG. 8). The housing of the attachment is made of duraluminum by milling. It has two clamps and two pin guides for positioning and fastening the attachment on the housing of the DCT. The attachment mounts 6 UV light emitting diodes of type HPL-H77FV1BA-V1 with a radiation wavelength of 370 nm, a divergence angle of 120° and a power of 25 mW. The sighting line is a DCT sighting line which is obtained from green light emitting diodes. To control the light emitting diodes of the illuminator a photosensor based on a L-32P3C phototransistor is used which is positioned coaxially to the light emitting diodes of the DCT illuminator when the attachment is fitted. In the electronic illuminator control circuit a current stabilizer microcircuit DD312 is used which controls the current passing through the series-parallel connected circuit of 6 light emitting diodes. Monitoring of the level of battery discharge is controlled using a circuit based on 2 n-p-n transistors of type KT3102 DM. The device is powered from two 9 V cells of the “Krona” type. A microswitch with a lug MX-1382 is used to prevent unauthorized engagement of the light emitting diodes in the unfitted position of the attachment. To block parasitic radiation from the light emitting diodes a filter of glass CC4 which is 3 mm thick is used, and a filter of glass OC11 which is 5 mm thick is mounted in the receiving channel of the sensor for suppression of UV radiation. The attachment mounted on the DCT makes it possible to read, store and transmit to a server over a radio channel invisible bar codes and images which have been printed using invisible inks based on a luminophore with absorption in the 370 nm range and fluorescence in the 620 nm range. After removing the DCT attachment, standard visible bar codes can be read.

1. Optical device which is designed to read information in the form of luminescent symbols and images, which consists of an illuminator with an array of light emitting diodes which excite luminescence and an optical system which projects the information which is being read onto the sensor of the scanner of the optoelectronic system which consists of an electronic control circuit, optical filter and objective lens with a light-guiding lamp which is provided with an output window, and which is connected to the housing of the data collection terminal or scanner by means of a constructive connection and switching connections for controlling the light emitting diodes of the device, characterized in that the switching connections between the scanner and device are implemented optically by means of photosensors which control the illuminator and sighting system, which are mounted in the housing of the device, and which receive the light pulses of the scanner.

2. Optical device as claimed in claim 1, wherein the photosensors are positioned coaxially with the light emitting diodes of the scanner.

3. Optical device as claimed in claim 1, wherein the prevented unauthorized engagement of the light emitting diodes of the illuminator and unallowable discharge of the power supply sources, it has a microswitch which blocks supply of electric power to the light emitting diodes in the unfitted state of the scanner.

4. Optical device as claimed in claim 1, wherein to block the incidence of parasitic long-wave radiation of the light emitting diodes of the illuminator onto the band of the receiving channel of the sensor, a light filter is used which transmits light with wavelengths below the upper boundary of the radiation band of shortwave light emitting diodes and which spectrally cuts off all other radiation.

5. Optical device as claimed in claim 1, wherein in the optical channel in the receiving window a light filter is mounted, including a replaceable one, with a passband which corresponds to the emission band of the excited luminescence spectrum, which filter blocks parasitic background from foreign sources of illumination and radiation of the primary wavelengths of the light emitting diodes of the illuminator, which radiation is reflected from the surface of the target.

6. Optical device as claimed in claim 1, wherein it has a wide angle lamp for preliminary searching for the luminescent (invisible) signal.

7. Optical device as claimed in claim 1, wherein the optical circuit has a sighting device which includes as a minimum two light emitting diodes with a visible radiation spectrum.

8. Optical device as claimed in claim 7, wherein the sighting device as a minimum has two lenses for forming the image of the sighting line.

9. Optical device as claimed in claim 7, wherein the sighting light emitting diodes are located near the focal plane on the optical axis of the lenses.

10. Optical device as claimed in claim 8, wherein the lenses of the sighting device have a spherical or cylindrical shape.

11. Optical device as claimed in claim 1, wherein it has electrical power supply which is independent of the scanner.

12. Optical device as claimed in claim 11, wherein electric power is supplied from self-contained current sources.

13. Optical device as claimed in claim 12, wherein the self-contained current source is made as a minimum from a single cell.

14. Optical device as claimed in claim 11, wherein electric power is supplied from the AC grid via a grid adapter with the necessary nominal voltage.

15. Optical device as claimed in claim 1, wherein a light absorbing coating for blocking the radiation of the light emitting diodes of the scanner is applied to the surface of the housing which adjoins the input window of the scanner, except for the zone of the field of view of the sensor.

16. Optical device as claimed in claim 1, wherein the array of light emitting diodes of the illuminator consists at least of two light emitting diodes which have different radiation spectra.

17. Optical device as claimed in claim 1, wherein the array of light emitting diodes of the illuminator consists at least of two light emitting diodes which have different radiation directional patterns.

18. Optical device as claimed in claim 1, wherein mechanically the illuminator consists as a minimum of one light emitting diode for illuminating the symbol or image, as a minimum two sighting light emitting diodes and components of the electronic power control circuit of the light emitting diodes which can be located in space on one, including a two-sided, plate or on several plates.

19. Optical device as claimed in claim 18, wherein the light emitting diodes with different radiation wavelengths which are mounted on the plate or plates of the illuminator are turned on simultaneously or independently by the photosensors.

20. Optical device as claimed in claim 18, wherein the light emitting diodes with different radiation directional patterns which are mounted on the plate or plates of the illuminator, are turned on simultaneously or independently by the photosensors.

21. Optical device as claimed in claim 1, wherein to turn on the array of light emitting diodes which consists of light emitting diodes at least with two different radiation spectra there is at least one manual switch which makes it possible to selectively start the light emitting diodes with the same radiation spectrum.

22. Optical device as claimed in claim 1, wherein to turn on the array of light emitting diodes which consists of light emitting diodes at least with two different radiation directional patterns there is at least one manual switch which makes it possible to selectively start the light emitting diodes with the same directional pattern.

23. Optical device as claimed in claim 1, wherein it has a screen to protect the operator from the radiation of the light emitting diodes and from the incidence of external background onto the receiving channel.

24. Optical device as claimed in claim 23, wherein the screen has the shape of a rectangular, round, oval or ellipsoidal bell.

25. Optical device as claimed in claim 24, wherein the internal surface of the screen has a mirror coating which concentrates the radiation of the light emitting diodes in the direction of the symbol which is being read.

26. Optical device as claimed in claim 1, wherein it has a constructive connection which ensures a strong connection between the inner surface of the housing of the optical device and the outer surface of the scanner housing.

27. Optical device as claimed in claim 1, wherein it is made in one housing or from detachable units, some of which or at least one is used for secure fastening to the scanner housing, in turn ensuring mechanical fastening of the units or unit with the optoelectronic system with self-contained power supply to it.

28. Optical device as claimed in claim 27, wherein for mechanical fastening it has as a minimum one clamp which fastens its housing on the scanner housing.

29. Optical device as claimed in claim 1, wherein it has an electronic circuit for stabilization and control of the power of the light emitting diodes which blocks the possibility of engaging the light emitting diodes of the optical device in the unfitted state of the scanner and signals the level of discharge of the self-contained cells.

30. Optical device as claimed in claim 1, wherein the electronic circuit for control of the current of the sighting light emitting diodes is implemented using an electronic switch.

31. Optical device as claimed in claim 30, wherein the electronic switch is made on the basis of a field effect transistor.

32. Optical device as claimed in claim 1, wherein the electronic control circuit of the current through the illuminating LED is implemented by a specialized LED stabilizer microcircuit.

33. Optical device as claimed in claim 1, wherein the electronic monitoring circuit of the cell discharge level is implemented by a bipolar transistorized circuit with a signal LED display.
